(19) United States
(12) Patent Application Publication
(10) Pub. No.: US 2026/0118912 A1
(43) Pub. Date: Apr. 30, 2026

(54) BATTERY-REPLACEABLE WIRELESS DEVICE AND METHOD OF PROTECTING SAME

(71) Applicant: Samsung Medison Co., Ltd., Hongcheon-gun (KR)

(72) Inventors: Hwanjo Lee, Seoul (KR); Namwoong Kim, Seoul (KR)

(73) Assignee: SAMSUNG MEDISON CO., LTD., Hongcheon-gun (KR)

(21) Appl. No.: 19/098,623

(22) Filed: Apr. 2, 2025

(30) Foreign Application Priority Data
Oct. 30, 2024 (KR) 10-2024-0151505

(51) Int. Cl. G06F 1/16; G01N 29/24; G01S 7/521; G01S 7/62; G06F 1/26; G06F 1/3212

(52) U.S. Cl. CPC G06F 1/1635; G01N 29/2481; G01S 7/521; G01S 7/62; G06F 1/1677; G06F 1/263; G06F 1/3212

(57) ABSTRACT

Provided are a battery-replaceable wireless device and a method of protecting the battery-replaceable wireless device. The wireless device includes a power supply module supplying power from the battery included in the wireless device, a cover sensing module sensing a coupling degree of a battery cover with respect to a battery holder into which the battery is inserted, a memory storing instructions, and at least one processor including processing circuitry, wherein the instructions, when executed individually or collectively by the at least one processor, cause the wireless device to sense, via the cover sensing module, that the battery cover starts to be separated from the battery holder; and perform a sequence for finishing operation of the wireless device based on the sensing that the battery cover starts to be separated from the battery holder.

### CROSS-REFERENCE TO RELATED APPLICATION

This application is based on and claims priority under 35 U.S.C. § 119 to Korean Patent Application No. 10-2024-0151505, filed on Oct. 30, 20204, in the Korean Intellectual Property Office, the disclosure of which is incorporated by reference herein in its entirety.

### BACKGROUND

### 1. Field

The disclosure relates to a battery-replaceable wireless device, and a control method for protecting the same when replacing a battery.

### 2. Description of the Related Art

A wireless device may transmit data or receive power without using a cable or wired connection. The wireless device provides a user with a high level of mobility, convenience, and flexibility based on wireless communication technology.

Most wireless devices operate by using batteries, and thus, the battery needs to be charged or replaced. When a battery is suddenly removed from a wireless device, loss of data that is being worked on may occur, and internal components of the wireless device may be damaged.

### SUMMARY

Additional aspects will be set forth in part in the description which follows and, in part, will be apparent from the description, or may be learned by practice of the presented embodiments of the disclosure.

According to an embodiment, a wireless device including a replaceable battery may be provided. The wireless device may include a power supply module configured to supply power from a battery included in the wireless device, a cover sensing module configured to sense a coupling degree of a battery cover with respect to a battery holder into which the battery is inserted, a memory configured to store instructions, and at least one processor including a processing circuitry. The instructions, when executed individually or collectively by the at least one processor, may cause the wireless device to sense that the battery cover starts to separate from the battery holder via the cover sensing module, and perform a sequence for finishing operation of the wireless device based on the sensing that the battery cover starts to separate from the battery holder.

According to an embodiment, a method of controlling a battery-replaceable wireless device is provided. The method of controlling the wireless device may include sensing that a battery cover starts to separate from a battery holder via a cover sensing module, and performing a sequence for finishing operation of the wireless device based on the sensing that the battery cover starts to separate from the battery holder.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are diagrams showing an ultrasound imaging system including a wireless device and an ultrasound imaging apparatus;

FIGS. 2A, 2B, 2C, and 2D are diagrams showing an ultrasound imaging apparatus including a wireless device, according to an embodiment;

FIG. 3 is a diagram illustrating a method of finishing operation of a wireless device, performed by the wireless device sensing the opening of a battery cover, according to an embodiment;

FIG. 4 is a flowchart illustrating a method of finishing operation of a wireless device, performed by the wireless device sensing the opening of a battery cover, according to an embodiment;

FIG. 5 is a block diagram of a wireless device according to an embodiment;

FIG. 6 is a diagram showing a cover sensing module of a wireless device, according to an embodiment;

FIG. 7 is a diagram showing a cover sensing module of a wireless device, according to an embodiment;

FIG. 8 is a diagram illustrating a method of providing a notification for securing waterproofing of a wireless device, according to an embodiment;

FIG. 9 is a diagram illustrating a method of sensing, by a wireless device, opening of a battery cover by using a pressure sensor, according to an embodiment;

FIG. 10 is a diagram illustrating a method of sensing, by a wireless device, opening of a battery cover by using a switch, according to an embodiment; and

FIG. 11 is a flowchart illustrating a method of finishing operations of a wireless device when the wireless device senses opening of a battery cover, according to an embodiment.

### DETAILED DESCRIPTION

Throughout the disclosure, the expression “at least one of a, b or c” indicates only a, only b, only c, both a and b, both a and c, both b and c, all of a, b, and c, or variations thereof.

Hereinafter, an embodiment will be described in detail with reference to accompanying drawings to the extent that one of ordinary skill in the art would be able to carry out the disclosure. However, the disclosure may be implemented in various manners, and is not limited to one or more embodiments described herein. In addition, components irrelevant with the description are omitted in the drawings for clear description, and like reference numerals are used for similar components throughout the entire specification.

The terms used in the disclosure are selected from among common terms that are currently widely used in consideration of their functions in the disclosure, but the terms may be different according to an intention of one of ordinary skill in the art, a precedent, or the advent of new technology. Therefore, the terms used in the disclosure are not merely designations of the terms, but the terms are defined based on the meaning of the terms and content throughout the disclosure.

It will be understood that although the terms “first,” “second,” etc. may be used herein to describe various components, these components should not be limited by these terms. These components are only used to distinguish one component from another.

The terms used in the specification are merely used to describe particular embodiments of the disclosure, and are not intended to limit the disclosure. An expression used in the singular encompasses the expression of the plural, unless it has a clearly singular meaning in the context. Throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

The present specification does not explain all of the elements of the embodiments, and content common in the technical field to which the present disclosure belongs or same content among the embodiments will be omitted. In the specification, terminologies ‘module’ or ‘unit’ may be implemented by one or combination of two or more of hardware, software, and firmware, and according to the embodiments, a plurality of ‘modules’ or ‘units’ may be implemented as one element or one ‘module’ or ‘unit’ may include a plurality of elements.

Phrases such as “in some embodiments of the disclosure” or “in one embodiment” throughout the specification may not necessarily denote the same embodiment.

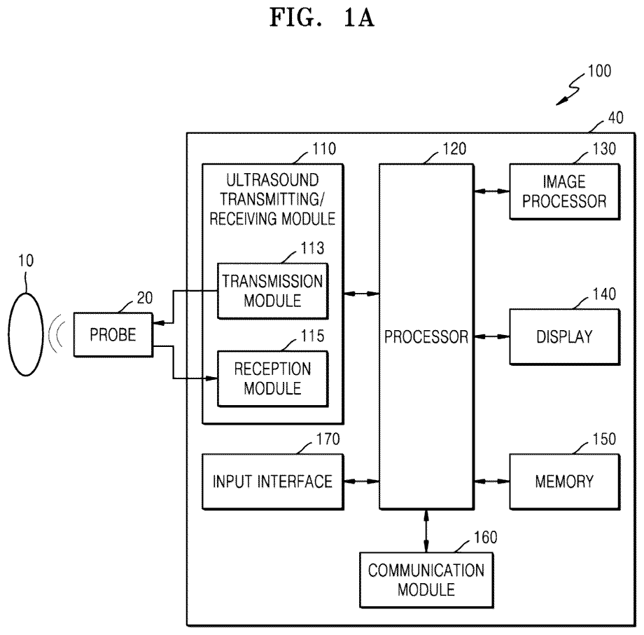

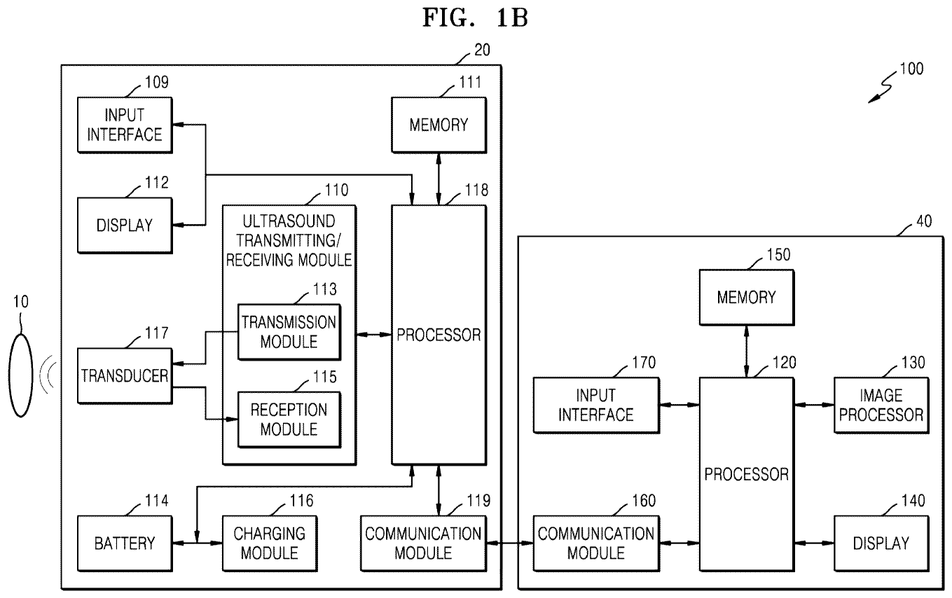

Referring to FIGS. 1A and 1B, an ultrasound imaging system 100 may include a wireless device 20 and an ultrasound imaging apparatus 40.

According to an embodiment, the wireless device 20 may interact with the ultrasound imaging apparatus 40.

The wireless device 20 may include an ultrasound wireless probe. For convenience of description, the ultrasound wireless probe may be referred to as a probe. The ultrasound imaging apparatus 40 may be implemented in a portable type, as well as a cart type. Examples of a portable ultrasound imaging apparatus may include a probe, a smartphone including applications, a laptop computer, a personal digital assistant (PDA), or a table PC, but are not limited thereto. The ultrasound imaging apparatus 40 may be implemented in a probe-integrated type.

The probe 20 may include a wireless device that is wirelessly connected to the ultrasound imaging apparatus 40 and wirelessly communicates with the ultrasound imaging apparatus 40, and/or a hybrid probe that is connected to the ultrasound imaging apparatus 40 via wired or wirelessly and communicates with the ultrasound imaging apparatus 40 via wire or wirelessly.

According to some embodiments, as shown in FIG. 1A, the ultrasound imaging apparatus 40 may include an ultrasound transmitting/receiving module 110, and as shown in FIG. 1B, the probe 20 may include the ultrasound transmitting/receiving module 110. According to some embodiments, the ultrasound imaging apparatus 40 and the probe 20 may both include the ultrasound transmitting/receiving module 110.

According to some embodiments, the probe 20 may include at least one of an image processor 130, a display 140, or an input interface 170, or a combination thereof. In the disclosure, descriptions about the ultrasound transmitting/receiving module 110, the image processor 130, the display 140, or the input interface 170 included in the ultrasound imaging apparatus 40 may be also applied to the ultrasound transmitting/receiving module 110, the image processor 130, the display 140, or the input interface 170 included in the probe 20.

FIG. 1A is a block diagram showing the ultrasound imaging system 100 including the probe when the wireless device 20 is the probe or the hybrid probe.

The probe 20 may include a plurality of transducers 117. The plurality of transducers 117 may be arranged in a certain array to be implemented as an array of the transducers 117. The array of transducers 117 may correspond to a one-dimensional (1D) or a two-dimensional (2D) array. The plurality of transducers 117 may send an ultrasound signal to an object 10 according to a transmission signal applied from a transmission module 113. The plurality of transducers 117 may receive the ultrasound signal (echo signal) reflected by the object 10 to generate a reception signal. Also, the ultrasound imaging apparatus 40 may be connected to one or plurality of probes 20 according to an implementation type.

When the probe 20 is a hybrid probe, the probe 20 may include a cable and a connector that may be connected to a connector of the ultrasound imaging apparatus 40.

The probe 20 according to the embodiment may be implemented in a 2D probe. When the probe 20 is implemented in a 2D probe, the plurality of transducers 117 included in the probe 20 may be two-dimensionally arranged to form a 2D array of transducers 117.

For example, the 2D array of transducers 117 may include a plurality of sub-arrays each including the plurality of transducers 117 arranged in a first direction, in a second direction that is different from the first direction.

Also, when the probe 20 according to the embodiment is implemented as a 2D probe, the ultrasound transmitting/receiving module 110 may include at least one of an analog beamformer or a digital beamformer. Also, according to an embodiment, the 2D probe may include at least one of the analog beamformer or the digital beamformer, or a combination thereof according to the implementation type.

The processor 120 controls the transmission module 113 so as to form a transmission signal to be applied to each of the transducers 117, in consideration of locations and a focusing point of the plurality of transducers 117 included in the probe 20.

The processor 120 may control a reception module 115 so as to generate ultrasound data, by performing an analog-to-digital conversion on a reception signal transmitted from the probe 20 and adding the digitally converted reception signals in consideration of the locations and focusing point of the plurality of transducers 117.

When the probe 20 is implemented as the 2D probe, the processor 120 may calculate a time delay value for digital beamforming for each sub-array, with respect to each of the plurality of sub-arrays included in the 2D array of transducers 117. Also, the processor 120 may calculate a time delay value for analog beamforming with respect to each of the transducers 117 included in any one of the plurality of sub-arrays. The processor 120 may control the analog beamformer and the digital beamformer so as to form the transmission signal to be applied to each of the plurality of transducers 117, according to the time delay value for analog beamforming and the time delay value for the digital beamforming. Also, the processor 120 may control the analog beamformer to sum the signals transmitted from the plurality of transducers 117 for each sub-array, according to the time delay value for the analog beamforming. The processor 120 may control the ultrasound transmitting/receiving module 110 so as to perform the analog-to-digital conversion on the summed signal for each sub-array. Also, the processor 120 may control the digital beamformer so as to generate the ultrasound data by adding the digital-converted signals according to the time delay value for the digital beamforming.

The image processor 130 may generate or process the ultrasound image by using the generated ultrasound data.

The display 140 may display the generated ultrasound image, and various information processed in the ultrasound imaging apparatus 40 or the probe 20. The probe 20 or the ultrasound imaging apparatus 40 may include one or a plurality of displays 140 according to the implementation type. Also, the display 140 may include a touch panel or a touch screen. Also, the display 140 may include a flexible display.

The processor 120 may control the overall operations of the ultrasound imaging apparatus 40 and may control the operations of the components in the ultrasound imaging apparatus 40. The processor 120 may perform or control the various operations or functions of the ultrasound imaging apparatus 40 by executing programs or instructions stored in the memory 150. Also, the processor 120 may receive the control signal from the input interface 170 or an external device to control the operations of the ultrasound imaging apparatus 40.

The ultrasound imaging apparatus 40 includes a communication module 160, and may be connected to and communicate with the external device (e.g., probe 20, server, medical apparatus, portable device (smart phone, tablet PC, wearable devices, etc.)) via the communication module 160.

The communication module 160 may include one or more components enabling the communication with the external device. The communication module 160 may include, for example, at least one of a near field communication module, a wired communication module, or a wireless communication module.

The communication module 160 may receive a control signal or data from the external device. The processor 120 may control the operations of the ultrasound imaging apparatus 40 according to the control signal received through the communication module 160. Also, the processor 120 may control the external device according to the control signal by transmitting the control signal to the external device via the communication module 160. The external device may operate according to the control signal transmitted from the ultrasound imaging apparatus 40 or may process the data transmitted from the ultrasound imaging apparatus 40.

A program or application related to the ultrasound imaging apparatus 40 may be installed on the external device. The program or application installed on the external device may control the ultrasound imaging apparatus 40 or may operate according to the control signal or data transmitted from the ultrasound imaging apparatus 40.

The external device may receive or download the program or application related to the ultrasound imaging apparatus 40 from the ultrasound imaging apparatus 40, the probe 20, or the server, and install the program or application thereon to execute the program or application. The ultrasound imaging apparatus 40, the probe 20, or the server providing the program or application may include a recording medium storing instructions, commands, installation files, execution files, or related data of the corresponding program or application. The external device may be sold with the program or application installed thereon.

The memory 150 may store various data or programs for driving and controlling the ultrasound imaging apparatus 40, input/output ultrasound data, input/output ultrasound images, etc.

The input interface 170 may receive a user input for controlling the ultrasound imaging apparatus 40. For example, the user input may include an input of manipulating a button, a keypad, a mouse, a trackball, a jog switch, a knop, etc., an input of touching a touch pad or a touch screen, a voice input, a motion input, a bio-information input (e.g., iris recognition, fingerprint recognition, etc.), but is not limited thereto.

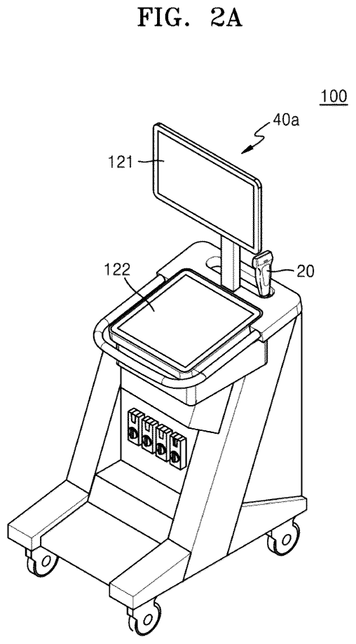

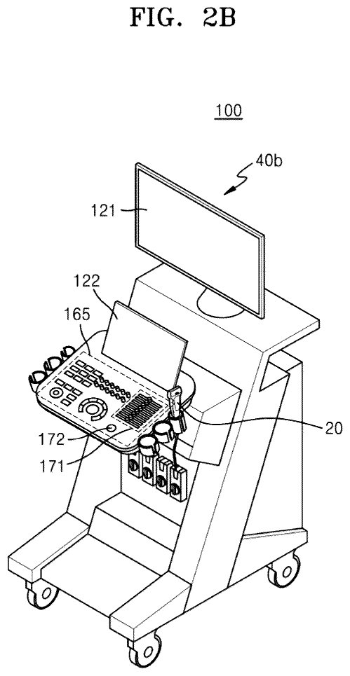

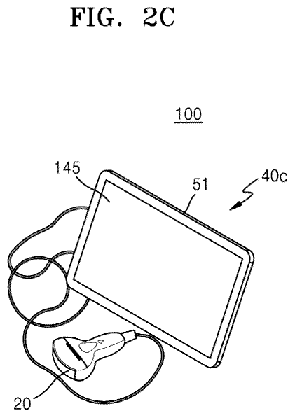

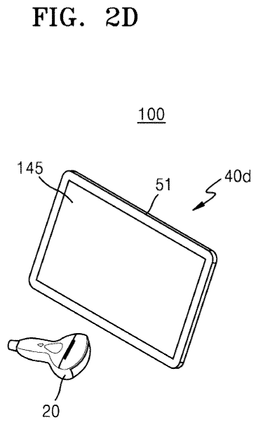

Examples of an ultrasound imaging system 100 according to the embodiment are described below with reference to FIGS. 2A, 2B, 2C, and 2D.

FIG. 1B is a controlling block diagram of the ultrasound imaging system 100 when the wireless device 20 is the wireless probe or the hybrid probe.

According to some embodiments, the ultrasound imaging apparatus 40 shown in FIG. 1B may be replaced with the ultrasound imaging apparatus 40 described above with reference to FIG. 1A.

According to some embodiments, the probe 20 shown in FIG. 1A may be replaced with the probe 20 described below with reference to FIG. 1B.

The probe 20 may include a display 112, a transmission module 113, a battery 114, the transducers 117, a charging module 116, the reception module 115, an input interface 109, a processor 118, and a communication module 119. In FIG. 1B, the probe 20 includes the transmission module 113 and the reception module 115, but according to the implementation type, the probe 20 may include only some of the components in the transmission module 113 and the reception module 115, and some of the components in the transmission module 113 and the reception module 115 may be included in the ultrasound imaging apparatus 40. Also, according to an embodiment, the probe 20 may further include an image processor 130.

The transducer 117 may include a plurality of transducers. The plurality of transducers are arranged in a certain arrangement to be implemented as a transducer array. The transducer array may correspond to a 1D or a 2D array. The plurality of transducers may send an ultrasound signal to an object 10 according to a transmission signal applied from a transmission module 113. Also, the plurality of transducers may receive the ultrasound signal reflected by the object 10 to form or generate an electrical reception signal.

The charging module 116 may charge the battery 114. The charging module 116 may receive electric power from the outside. According to an embodiment, the charging module 116 may receive electric power wirelessly. Also, according to an embodiment, the charging module 116 may receive electric power via wires. The charging module 116 may transfer the received power to the battery 114.

The processor 118 may control the transmission module 113 so as to generate or form the transmission signal to be applied to each of the plurality of transducers taking into account the locations of the plurality of transducers and the focusing point.

The processor 118 controls the reception module 115 to generate ultrasound data by performing analog-to-digital conversion on the reception signal transmitted from the transducer 117 and adding digital-converted reception signals taking into account the locations of the plurality of transducers and the focusing point. According to an embodiment, when the probe 20 includes the image processor 130, the ultrasound image may be generated by using the generated ultrasound data.

When the probe 20 is implemented as the 2D probe, the processor 118 may calculate a time delay value for digital beamforming for each sub-array, with respect to each of the plurality of sub-arrays included in the 2D transducer array. Also, the processor 118 may calculate a time delay value for analog beamforming with respect to each of the transducers included in any one of the plurality of sub-arrays. The processor 118 may control the analog beamformer and the digital beamformer so as to form the transmission signal to be applied to each of the plurality of transducers, according to the time delay value for analog beamforming and the time delay value for the digital beamforming. Also, the processor 118 may control the analog beamformer to sum the signals transmitted from the plurality of transducers for each sub-array, according to the time delay value for the analog beamforming. The processor 118 may control the ultrasound transmitting/receiving module 110 so as to perform the analog-to-digital conversion on the summed signal for each sub-array. Also, the processor 118 may control the digital beamformer so as to generate the ultrasound data by adding the digital-converted signals according to the time delay value for the digital beamforming.

The processor 118 may control the overall operations of the probe 20 and control the operations of the elements in the probe 20. The processor 118 may perform or control the various operations or functions of the probe 20 by executing programs or instructions stored in the memory 111. Also, the processor 118 may control the operations of the probe 20 by receiving a control signal from an input interface 109 of the probe 20 or an external device (e.g., the ultrasound imaging apparatus 40). Also, the processor 118 may receive the control signal from the input interface 109 or an external device to control the operations of the probe 20. The input interface 109 may receive a user input for controlling the probe 20. For example, the user input may include an input of manipulating a button, a keypad, a mouse, a trackball, a jog switch, a knop, etc., an input of touching a touch pad or a touch screen, a voice input, a motion input, a bio-information input (e.g., iris recognition, fingerprint recognition, etc.), but is not limited thereto.

The display 112 may display an ultrasound image generated by the probe 20, an ultrasound image generated by processing ultrasound data generated by the probe 20, an ultrasound image transmitted from the ultrasound imaging apparatus 40, or various information processed in the ultrasound imaging system 100. Also, the display 112 may further display status information of the probe 20. The status information of the probe 20 may include at least one of device information of the probe 20, battery status information of the probe 20, frequency band information of the probe 20, output information of the probe 20, information as to abnormality of the probe 20, setting information of the probe 20, or temperature information of the probe 20. The status information of the probe 20 may include information indicating that the battery cover starts to separate.

The probe 20 may include one or a plurality of displays 112 according to an implementation type. Also, the display 112 may include a touch panel or a touch screen. Also, the display 112 may include a flexible display.

The communication module 119 may transmit generated ultrasound data or ultrasound image wirelessly to the ultrasound imaging apparatus 40 via a wireless network. Also, the communication module 119 may receive a control signal and data from the ultrasound imaging apparatus 40.

The ultrasound imaging apparatus 40 may receive the ultrasound data or ultrasound image from the probe 20.

In an embodiment, when the probe 20 includes the image processor 130 that may generate ultrasound image by using the ultrasound data, the probe 20 may transmit the ultrasound data or ultrasound image generated by the image processor 130 to the ultrasound imaging apparatus 40.

In an embodiment, when the probe 20 does not include the image processor 130 that may generate the ultrasound image by using the ultrasound data, the probe 20 may transmit ultrasound data to the ultrasound imaging apparatus 40. The ultrasound data may include ultrasound raw data, and the ultrasound image may denote ultrasound image data.

The ultrasound imaging apparatus 40 may include the processor 120, the image processor 130, the display 140, the memory 150, the communication module 160, and the input interface 170.

The image processor 130 generates or processes the ultrasound image by using the ultrasound data transmitted from the probe 20.

The display 140 may display an ultrasound image transmitted from the probe 20, an ultrasound image generated by processing the ultrasound data transmitted from the probe 20, or various information processed in the ultrasound imaging system 100, etc. The ultrasound imaging apparatus 40 may include one or a plurality of displays 140 according to an implementation type. Also, the display 140 may include a touch panel or a touch screen. Also, the display 140 may include a flexible display.

The processor 120 may control the overall operations of the ultrasound imaging apparatus 40 and may control the operations of the components in the ultrasound imaging apparatus 40. The processor 120 may perform or execute various operations or functions of the ultrasound imaging apparatus 40 by executing a program or application stored in the memory 150. Also, the processor 120 may receive the control signal from the input interface 170 or an external device to control the operations of the ultrasound imaging apparatus 40.

The ultrasound imaging apparatus 40 includes a communication module 160, and may be connected to and communicate with the external device (e.g., probe 20, server, medical apparatus, portable device (smart phone, tablet PC, wearable devices, etc.)) via the communication module 160.

The communication module 160 may include one or more components enabling the communication with the external device. The communication module 160 may include, for example, at least one of a near field communication module, a wired communication module, or a wireless communication module.

The communication module 160 of the ultrasound imaging apparatus 40 and the communication module 119 of the probe 20 may communicate with each other via a network or by using a near field wireless communication method. For example, the communication module 160 of the ultrasound imaging apparatus 40 and the communication module 119 of the probe 20 may communicate with each other by using one of wireless data communication methods including wireless LAN, Wi-Fi, Bluetooth, ZigBee, Wi-Fi direct (WFD), infrared data association (IrDA), Bluetooth low energy (BLE), near field communication (NFC), wireless broadband internet (Wibro), world interoperability for microwave access (WiMAX), shared wireless access protocol (SWAP), wireless gigabit alliance (WiGig), RF communication, or 60 GHz millimeter waves near field communication, etc.

To this end, the communication module 160 of the ultrasound imaging apparatus 40 and the communication module 119 of the probe 20 may each include at least one of a wireless LAN communication module, Wi-Fi communication module, Bluetooth communication module, ZigBee communication module, WFD communication module, IRDA communication module, BLE communication module, NFC communication module, Wibro communication module, WiMAX communication module, SWAP communication module, WiGig communication module, RF communication module, or 60 GHz millimeter waves near field communication module.

In the embodiment, the probe 20 may transmit device information (e.g., ID information) of the probe 20 by using a first communication method (e.g., BLE) to the ultrasound imaging apparatus 40, and may be paired with the ultrasound imaging apparatus 40 wirelessly. Also, the probe 20 may transmit ultrasound data and/or ultrasound image to the ultrasound imaging apparatus 40 that is paired.

The device information of the probe 20 may include various information regarding a serial number, model name, or battery status of the probe 20.

The ultrasound imaging apparatus 40 may receive the device information (e.g., ID information) of the probe 20 from the probe 20 by using the first communication method (e.g., BLE) and may be paired with the probe 20 wirelessly. Also, the ultrasound imaging apparatus 40 may transmit an activation signal to the paired probe 20 and may receive ultrasound data and/or ultrasound image from the probe 20. Here, the activation signal may include a signal for controlling operations of the probe 20.

In the embodiment, the probe 20 may transmit device information (e.g., ID information) of the probe 20 by using the first communication method (e.g., BLE) to the ultrasound imaging apparatus 40, and may be paired with the ultrasound imaging apparatus 40 wirelessly. Also, the probe 20 may transmit the ultrasound data and/or ultrasound image to the ultrasound imaging apparatus 40 that is paired with the probe 20 in the first communication method, by using a second communication method (e.g., 60 GHz millimeter waves, Wi-Fi).

The ultrasound imaging apparatus 40 may receive the device information (e.g., ID information) of the probe 20 from the probe 20 by using a first communication method (e.g., BLE) and may be paired with the probe 20 wirelessly. Also, the ultrasound imaging apparatus 40 may transmit the activation signal to the paired probe 20 and may receive the ultrasound data and/or the ultrasound image from the probe 20 by using the second communication method (e.g., 60 GHz millimeter waves, Wi-Fi).

According to an embodiment, the first communication method used to pair the probe 20 and the ultrasound imaging apparatus 40 with each other may have a frequency band that is lower than that of the second communication method used when the probe 20 transmits the ultrasound data and/or the ultrasound image to the ultrasound imaging apparatus 40.

The display 140 of the ultrasound imaging apparatus 40 may display user interface (UI) indicating the device information of the probe 20. For example, the display 140 may display ID information of the wireless ultrasound probe 20, a pairing method with the probe 20, data communication status between the probe 20 and the ultrasound imaging apparatus 40, a method of performing data communication with the ultrasound imaging apparatus 40, or UI indicating the battery status of the probe 20, etc.

When the probe 20 includes the display 112, the display 112 of the probe 20 may display UI indicating the device information of the probe 20. For example, the display 112 may display ID information of the wireless ultrasound probe 20, a pairing method with the probe 20, data communication status between the probe 20 and the ultrasound imaging apparatus 40, a method of performing data communication with the ultrasound imaging apparatus 40, or UI indicating the battery status of the probe 20, etc.

The communication module 160 may receive a control signal or data from the external device. The processor 120 may control the operations of the ultrasound imaging apparatus 40 according to the control signal received through the communication module 160.

Also, the processor 120 may control the external device according to the control signal by transmitting the control signal to the external device via the communication module 160. The external device may operate according to the control signal transmitted from the ultrasound imaging apparatus 40 or may process the data transmitted from the ultrasound imaging apparatus 40.

The external device may receive or download the program or application related to the ultrasound imaging apparatus 40 from the ultrasound imaging apparatus 40, the probe 20, or the server, and install the program or application thereon to execute the program or application. The ultrasound imaging apparatus 40, the probe 20, or the server providing the program or application may include a recording medium storing instructions, commands, installation files, execution files, or related data of the corresponding program or application. The external device may be sold with the program or application installed thereon.

The memory 150 may store various data or programs for driving and controlling the ultrasound imaging apparatus 40, input/output ultrasound data, input/output ultrasound images, etc.

FIGS. 2A, 2B, 2C, and 2D are diagrams showing the ultrasound imaging apparatus 40 including a wireless device 20, according to an embodiment.

The wireless device 20 may be a probe.

Referring to FIGS. 2A and 2B, ultrasound imaging apparatuses 40a and 40b may each include a main display 121 and a sub-display 122. The main display 121 and the sub-display 122 may correspond to the display 140 of FIGS. 1A and 1B. At least one of the main display 121 or the sub-display 122 may be implemented as a touch screen. At least one of the main display 121 or the sub-display 122 may display the ultrasound image or various information processed in the ultrasound imaging apparatus 40a or 40b. Also, at least one of the main display 121 or the sub-display 122 may be implemented as a touch screen and may provide a graphic user interface (GUI) so as to receive an input of data for controlling the ultrasound imaging apparatus 40a or 40b from a user. For example, the main display 121 may display an ultrasound image, and the sub-display 122 may display a control panel for controlling the display of the ultrasound image as a GUI. The sub-display 122 may receive an input of data for controlling the display of the image via the control panel represented as the GUI. For example, a time gain compensation (TGC) button, a lateral gain compensation (LGC) button, a freeze button, a track ball, a jog switch, or a knop may be provided as a GUI on the sub-display 122.

The ultrasound imaging apparatuses 40a and 40b may control the display of the ultrasound image on the main display 121 by using the received data. Also, the ultrasound imaging apparatus 40a and 40b may be connected to the probe 20 via wire or wirelessly to send/receive the ultrasound signal to/from an object.

Referring to FIG. 2B, the ultrasound imaging apparatus 40b may further include a control panel 165, in addition to the main display 121 and the sub-display 122. The control panel 165 may include a button, a track ball, a jog switch, a knop, etc., and may receive an input of data for controlling the ultrasound imaging apparatus 40b from the user. For example, the control panel 165 may include a TGC button 171, a freeze button 172, etc. The TGC button 171 is a button for setting a TGC value according to a depth of the ultrasound image. Also, when sensing an input of the freeze button 172 while scanning the ultrasound image, the ultrasound imaging apparatus 40b may maintain the status of displaying a frame image at the corresponding point in time, capture the frame image of the corresponding point in time, or store the frame image at the corresponding point in time.

In addition, the button, the track ball, the jog switch, the knop, etc. included in the control panel 165 may be provided as the GUI on the main display 121 or the sub-display 122. Also, the ultrasound imaging apparatus 40a and 40b may be connected to the probe 20 to transmit/receive the ultrasound signal to/from an object.

Also, the ultrasound imaging apparatus 40a or 40b may include various types of input/output interfaces such as a speaker, light emitting diode (LED), a vibration device, etc. For example, the ultrasound imaging apparatus 40a or 40b may output various information in the type of graphic, sound or vibration through the input/output interface. Also, the ultrasound imaging apparatus 40a or 40b may output various notifications or data through the input/output interface.

Referring to FIGS. 2C and 2D, ultrasound imaging apparatuses 40c and 40d may be each implemented as a portable type. Examples of the ultrasound imaging apparatus 40c or 40d may include a smart phone including a probe and applications, a laptop computer, a personal digital assistant (PDA), a tablet personal computer (PC), etc., but are not limited thereto.

The ultrasound imaging apparatus 40c may include a main body 51. Referring to FIG. 2C, the probe 20 may be connected to one side of the main body 51 via a wire. To this end, the main body 51 may include a connection terminal in which a cable connected to the probe 20 is attachable/detachable. The probe 20 may include a cable including a connection terminal that may be connected to the main body 51.

Referring to FIG. 2D, the probe 20 may be wirelessly connected to the ultrasound imaging apparatus 40d. The main body 51 may include an input/output interface (e.g., a touch screen). The input/output interface may display the ultrasound image, various information processed in the ultrasound imaging apparatus, or GUI.

The ultrasound imaging apparatus 40d and the probe 20 may establish communication or may be paired with each other via near field wireless communication. For example, the ultrasound imaging apparatus 40d and the probe 20 may perform the communication by using Bluetooth, BLE, Wi-Fi, or WFD.

The ultrasound imaging apparatus 40c or 40d may control the probe 20 or output information regarding the probe 20, by executing the program or application related to the probe 20. The ultrasound imaging apparatus 40c or 40d may perform the operation regarding the probe 20, while communicating with a certain server. The probe 20 may be registered to the ultrasound imaging apparatus 40c or 40d, or to a certain server. The ultrasound imaging apparatus 40c or 40d may communicate with the registered probe 20 and may perform the operations related to the probe 20.

Also, the ultrasound imaging apparatus 40c or 40d may include various types of input/output interfaces such as a speaker, light emitting diode (LED), a vibration device, etc. For example, the ultrasound imaging apparatus 40c or 40d may output various information in the type of graphic, sound or vibration through the input/output interface. Also, the ultrasound imaging apparatus 40c or 40d may output various notifications or data through the input/output interface.

According to the embodiment, the ultrasound imaging apparatus 40a, 40b, 40c, or 40d may process the ultrasound image or obtain additional information from the ultrasound image by using an artificial intelligence (AI) model. According to the embodiment, the ultrasound imaging apparatus 40a, 40b, 40c, or 40d may generate the ultrasound image or may perform processes such as a calibration, image quality enhancement, encoding, or decoding on the ultrasound image, by using the AI model. Also, according to the embodiment, the ultrasound imaging apparatus 40ab 40b, 40c, or 40d may perform the processes such as baseline definition, anatomical information acquisition, lesion information acquisition, surface extraction, boundary definition, length measurement, area measurement, volume measurement, or annotation generation, by using the AI model.

The AI model may be provided on the ultrasound imaging apparatus 40a, 40b, 40c, or 40d or on a server.

The AI model may be implemented by using various artificial neural networks or deep neural networks. Also, the AI model may be trained and generated by using various machine learning algorithms or deep learning algorithms. The AI model may be implemented by using, for example, convolutional neural network (CNN), recurrent neural network (RNN) or generative adversarial network (GAN), a long short-term memory (LSTM), etc.

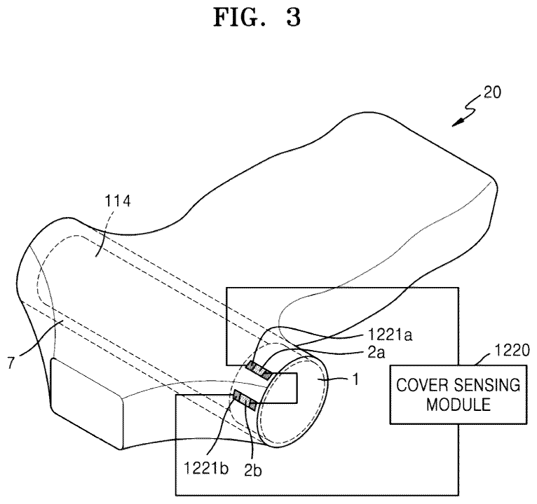

FIG. 3 is a diagram illustrating a method of finishing operation of a wireless device 20, performed by a wireless device 20 sensing the opening of a battery cover 1, according to an embodiment.

Referring to FIG. 3, the wireless device 20 may sense that the battery cover 1 may start to separate from a battery holder 7 via a cover sensing module 1220. Based on the sensing that the battery cover 1 starts to separate from the battery holder 7, the wireless device 20 may perform power-off sequence.

The wireless device 20 may include a battery-replaceable device. The wireless device 20 may include an ultrasound wireless probe, a portable phone, a portable laptop computer, or a wearable device, but is not limited thereto.

According to an embodiment, the power-off sequence of the wireless device 20 may include termination of an operating system. Accordingly, the wireless device 20 may address the issue of not storing the data (e.g., ultrasound data) due to a sudden termination.

According to the embodiment, when the wireless device 20 is an ultrasound wireless probe, the power-off sequence of the wireless device 20 may include an operation of stopping the operations of an ultrasound transmitter and an ultrasound receiver. Also, the power-off sequence of the wireless device 20 may include an operation of stopping operations of a high-voltage module. The high-voltage module may be a module for generating power source for driving the ultrasound transmitter. Also, the power-off sequence of the wireless device 20 may include an operation of shutting-off the power supplied to the transducer. Accordingly, the wireless device 20 may prevent a permanent damage due to a sudden change in a voltage, which may cause breaking of a polarization of the transducer.

The battery cover 1 of the wireless device 20 may include a screw-type cover that is rotated to be opened/closed, a cover that is pushed or pulled out, a sliding-type cover, or a cover type, but is not limited thereto.

The wireless device 20 may detect whether the battery cover 1 is locked to a reference lock position of the battery holder 7 via the cover sensing module 1220.

According to the embodiment, the cover sensing module 1220 may include two electrodes 1221a and 1221b provided in the battery holder 7. The battery cover 1 may have a conductor inside (side attached to the battery holder 7). For example, the conductor may include a pair of conductors 2a and 2b that are electrically connected to each other, as shown in FIG. 3. The battery cover 1 may further include a main conductor (not shown) therein for connecting a battery 114 to a power module of the wireless device 20, in addition to the pair of conductors 2a and 2b.

Also, as shown in FIG. 3, when the battery cover 1 is locked to the reference lock position of the battery holder 7, the two electrodes 1221a and 1221b provided in the battery holder 7 may come into contact with the conductors 2a and 2b of the battery cover 1. When the two electrodes 1221a and 1221b of the battery holder 7 come into contact with the conductors 2a and 2b of the battery cover 1, the two electrodes 1221a and 1221b may be electrically connected to each other.

The cover sensing module 1220 may sense a current value flowing in the electrodes 1221a and 1221b when the two electrodes 1221a and 1221b are electrically connected to each other. The wireless device 20 may determine that the battery cover 1 is locked to the reference lock position of the battery holder 7, based on the current value sensed by the cover sensing module 1220.

The wireless device 20 may sense that the battery cover 1 may start to separate from the battery holder 7 via the cover sensing module 1220. As the user performs the operation of separating the battery cover 1 from the battery holder 7, the conductors 2a and 2b of the battery cover 1 may be isolated from the electrodes 1221a and 1221b of the battery holder 7. As the conductors 2a and 2b of the battery cover 1 are isolated from the electrodes 1221a and 1221b of the battery holder 7, the electrodes 1221a and 1221b of the battery holder 7 may not be electrically connected to each other. Because the electrodes 1221a and 1221b of the battery holder 7 are not electrically connected to each other, the cover sensing module 1220 may not sense the current value.

The wireless device 20 may detect that the electrodes 1221a and 1221b of the battery holder 7 are disconnected from the electrically connected status, based on the current value of the cover sensing module 1220. Also, the wireless device 20 may determine that the battery cover 1 starts to separate from the battery holder 7 based on that the electric connection between the electrodes 1221a and 1221b of the battery holder 7 is disconnected.

In this case, even when the conductors 2a and 2b of the battery cover 1 are separated from the electrodes 1221a and 1221b of the battery holder 7, the main conductor of the battery cover 1 is still connected to the battery 114, and thus, the wireless device 20 may receive the power supply from the battery 114. Also, before the battery cover 1 is completely separated from the battery holder 7 and the main conductor of the battery cover 1 is disconnected from the battery 114, the wireless device 20 may perform processes for finishing the operations of the wireless device 20.

According to an embodiment, after the wireless device 20 is turned on, based on the determination that the battery cover 1 is not coupled to the reference lock position of the battery holder 7, the wireless device 20 may output a notification notifying that the coupling degree of the battery cover 1 to the battery holder 7 is to be improved.

The notification guiding that the coupling degree of the battery cover 1 is to be improved may include a notification that guides the coupling degree of the battery cover 1 to be improved a waterproof securing position.

According to the embodiment, the cover sensing module 1220 may include a pressure sensor. Based on the determination that the force applied to the battery cover 1 is a reference pressure or less via the pressure sensor, the wireless device 20 may determine that the battery cover 1 starts to separate from the battery holder 7.

According to an embodiment, the cover sensing module 1220 may include a switch. The wireless device 20 may determine that the battery cover 1 starts to separate from the battery holder 7, based on that the pushing of the switch is released.

According to an embodiment, based on the determination that the battery cover 1 starts to separate from the battery holder 7, the wireless device 20 may output a notification notifying that the operation of the wireless device 20 is finished.

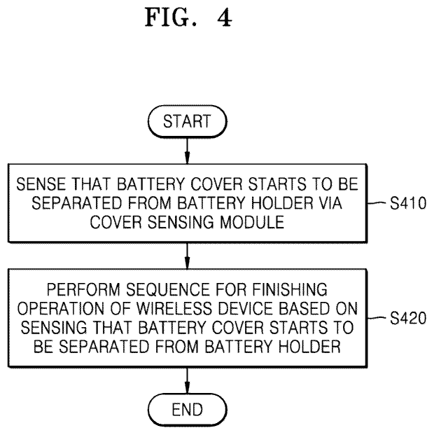

FIG. 4 is a flowchart illustrating a method of finishing operation of the wireless device 20, performed by the wireless device 20 sensing the opening of a battery cover, according to an embodiment.

In operation S410, the wireless device 20 may sense that the battery cover starts to separate from the battery holder via the cover sensing module.

According to the embodiment, the cover sensing module may include two separate electrodes. The two separate electrodes may be configured to be connected to each other when the battery cover is locked to a reference lock position of the battery holder.

The cover sensing module may detect a reference current value determined in advance when the two electrodes are connected. Also, the cover sensing module may detect the current value close to 0 when the two electrodes are separated.

The wireless device 20 may determine that the battery cover starts to separate from the battery holder, based on that the current value detected by the cover sensing module is lowered close to 0 from the reference current value.

According to the embodiment, the cover sensing module may include a pressure sensor detecting the force applied to the battery cover. The pressure sensor may be provided so that the reference pressure value or greater may be detected when the battery cover is locked to the reference lock position of the battery holder. The wireless device 20 may determine that the battery cover starts to separate from the battery holder based on that the pressure value of the pressure sensor is falls below a reference pressure value.

According to the embodiment, the cover sensing module may include a switch. The switch may be provided to be pushed when the battery cover is locked to the reference lock position of the battery holder. The wireless device 20 may determine that the battery cover starts to separate from the battery holder, based on that the pushing of the switch is released.

In operation S420, the wireless device 20 may perform a sequence for finishing the operation of the wireless device 20, based on the sensing that the battery cover starts to separate from the battery holder.

The sequence for finishing the operations of the wireless device 20 may include operations of finishing an operating system of the wireless device 20 and turning off the wireless device 20, but are not limited thereto.

When the wireless device 20 is an ultrasound wireless probe, the sequence for finishing the operations of the wireless device 20 may include at least one of an operation of controlling the ultrasound transmitter to stop transmitting the ultrasound waves, an operation of stopping power supply to the ultrasound transmitter, an operation of stopping receiving ultrasound waves by controlling the ultrasound receiver, or an operation of stopping power supply to the ultrasound receiver.

When the wireless device 20 is the ultrasound wireless probe, an operation of stopping transmitting the ultrasound wave by controlling the ultrasound transmitter and stopping power supply to the ultrasound transmitter may be performed first. For example, the wireless device 20 may perform the sequence of finishing the operation of the wireless device 20 in an order of stopping the transmission of ultrasound wave by controlling the ultrasound transmitter, stopping the power supply to the ultrasound transmitter, stopping the ultrasound reception by controlling the ultrasound receiver, stopping the power supply to the ultrasound receiver, finishing the operating system of the wireless device 20, and turning off the wireless device 20. An issue of permanently damaging the polarization of piezoelectric material in the transmitter due to the sudden turning-off of the power may be prevented by firstly performing the process of stopping the transmission of ultrasound wave and stopping the power supply to the ultrasound transmitter.

According to an embodiment, the wireless device 20 may output a notification for notifying that the operation of the wireless device 20 is finished, and then may perform the sequence for finishing the operation of the wireless device 20 based on the sensing that the battery cover starts to separate from the battery holder. The notification for notifying that the operation of the wireless device 20 is finished may include a buzzer sound, flickering, or voice notification notifying that the operation is finished, in correspondence with the finishing of operation, but is not limited thereto.

According to an embodiment, the wireless device 20 may output a notification guiding that the locking degree of the battery cover with respect to the battery cover is to be improved, based on the determination that the battery cover is not locked to the reference lock position of the battery holder. For example, after turning on the wireless device 20, the wireless device 20 may detect whether the battery cover is locked to the reference lock position of the battery holder. Based on the determination that the battery cover is not locked to the reference lock position for a reference time duration after turning on the wireless device 20, the wireless device 20 may output a notification guiding that the locking degree of the battery cover with respect to the battery holder is to be improved.

The notification guiding that the locking degree of the battery cover with respect to the battery holder is to be improved may include a buzzer sound determined in advance corresponding to the degree less than the reference locking degree, flickering, or voice notification notifying that the locking degree of the battery cover is to be improved, but is not limited thereto. For example, the notification guiding that the locking degree of the battery cover with respect to the battery holder is to be improved may include a voice notification that guides improvement of the locking degree of the battery cover in order to secure the waterproof of the wireless device 20.

According to an embodiment, based on the determination that the battery cover is locked to the reference lock position of the battery holder, the wireless device 20 may output a notification sound notifying that the battery cover is locked to the reference lock position of the battery holder.

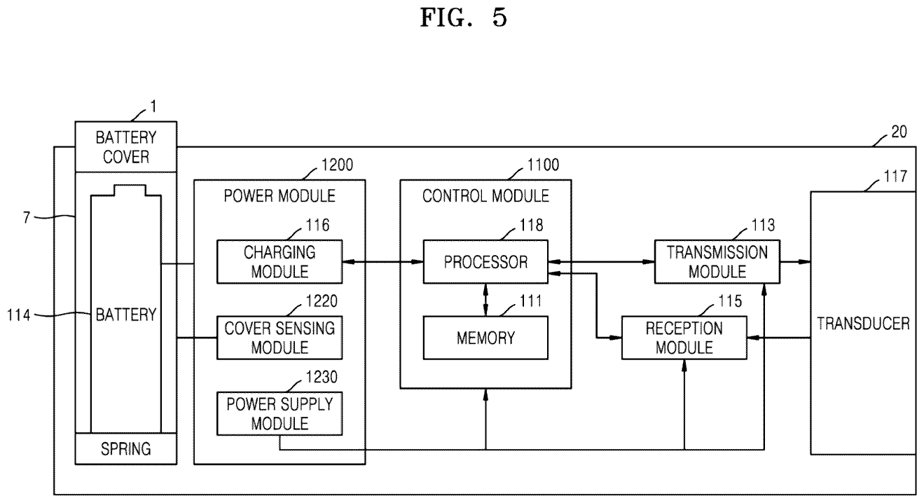

FIG. 5 is a block diagram of the wireless device 20 according to an embodiment.

Referring to FIG. 5, the wireless device 20 may be an ultrasound wireless probe. The wireless device 20 may include a control module 1100, a power module 1200, the transmission module 113, the reception module 115, and the transducer 117.

The control module 1100 may include the processor 118 and a memory 111. The control module 1100 may be referred to as a micro controller unit (MCU). The control module 1100 may control the power module 1200, the transmission module 113, the reception module 115, and the transducer 117 of the wireless device 20.

The transmission module 113, the reception module 115, and the transducer 117 may be described with reference to FIG. 1B.

The power module 1200 may include a charging module 116, the cover sensing module 1220, and a power supply module 1230. The power module 1200 may be connected to the battery.

The charging module 116 may acquire the power from the outside to charge the battery 114. The charging module 116 may be described with reference to FIG. 1B.

The power supply module 1230 may supply power to each module in the wireless device 20.

The cover sensing module 1220 may include an electrode sensor, a pressure sensor, or a switch, but is not limited thereto. The sensing portion of the cover sensing module 1220 may be provided in the battery holder 7. As the battery cover 1 is released from the battery holder 7, a sensor value of the cover sensing module 1220 may be changed because the sensing portion of the cover sensing module 1220 may be electrically disconnected, pressure is reduced, or pushing of the switch is released.

The processor 118 may obtain the sensor value of the cover sensing module 1220. The processor 118 may determine that the battery cover 1 starts to separate from the battery holder 7 based on the sensor value of the cover sensing module 1220.

Based on the determination that the battery cover 1 starts to separate from the battery holder 7, the processor 118 may perform the sequence for finishing the operations of the wireless device 20.

According to the embodiment, the processor 118 may stop transmitting the ultrasound wave by controlling the transmission module 113. For example, the processor 118 may stop applying voltage to the transducer 117 by finishing the operation of the transmission module 113. Also, the processor 118 may stop the power supply to the transmission module 113. The voltage supplied to the transmission module 113 may be greater than the voltage supplied to another module.

When the power supplied to a circuit or system is suddenly blocked, electrical shock may occur or a power surge may occur in the circuit or the system. For example, when the connection to the battery is suddenly disconnected during replacing the battery, an excessive voltage greater than or equal to the reference voltage may be applied to the transducer 117.

The transducer 117 include a piezoelectric material, and a polarization is formed in the piezoelectric material. Because an electrical signal is applied to the piezoelectric material in which the polarization is formed, the piezoelectric material may output an ultrasound signal. However, when a voltage greater than or equal to the reference voltage is applied to the transducer 117, an electric field is excessively formed in the piezoelectric material and the polarization state may change or may become unstable. Accordingly, the electrical characteristics of the piezoelectric material may change, and the polarization may be permanently damaged. When the polarization in the transducer 117 is damaged, the ultrasound conversion efficiency of the piezoelectric material may be rapidly dropped or the transducer 117 may not operate.

Based on the determination that the battery cover 1 starts to separate from the battery holder 7, the applying of voltage to the transducer 117 is stopped, and the power is not supplied to the transmission module 113. Thus, the wireless device 20 may prevent the issue that the polarization of the transducer 117 may be permanently damaged because the battery 114 is removed during the operation of the transducer 117.

According to an embodiment, the processor 118 may stop receiving the ultrasound wave by controlling the reception module 115. For example, the processor 118 may finish the operation of the reception module 115 so as not to convert an ultrasound echo signal into an electrical signal. Also, the processor 118 may stop the power supply to the reception module 115.

According to the embodiment, the processor 118 may terminate the operating system of the wireless device 20. For example, the processor 118 may finish the storing operation of data that being worked on (e.g., ultrasound data, ultrasound image, system files, etc.). Also, for example, the processor 118 may perform the sequence of terminating the file system.

According to the embodiment, the processor 118 may stop the power supply to the control module 1100.

According to the embodiment, an order of operations for finishing the operation of the wireless device 20 may be determined in advance and stored.

For example, the sequence for finishing the operation of the wireless device 20 may include a step of stopping transmitting the ultrasound by controlling the transmission module 113, a step of stopping the power supply to the transmission module 113, a step of finishing the operating system, and a step of stopping the power supply to the control module 1100, which are sequentially performed.

Also, for example, the sequence for finishing the operation of the wireless device 20 may include a step of stopping transmitting the ultrasound by controlling the transmission module 113, a step of stopping the power supply to the transmission module 113, a step of stopping the ultrasound reception by controlling the reception module 115, a step of stopping the power supply to the reception module 115, a step of finishing the operating system, and a step of stopping the power supply to the control module 1100, which are sequentially performed.

When the wireless device 20 is not an ultrasound wireless probe, the wireless device 20 may not include the transmission module 113, the reception module 115, and the transducer 117.

The at least one processor 118 may sense that the battery cover 1 starts to separate from the battery holder 7 via the cover sensing module 1220.

The at least one processor 118 may perform the sequence for finishing the operation of the wireless device 20, based on the sensing that the battery cover 1 starts to separate from the battery holder 7.

The cover sensing module 1220 may include two separate electrodes, and the two separate electrodes may be connected to each other when the battery cover 1 is locked to a reference lock position of the battery holder 7. In this case, the at least one processor 118 may determine that the battery cover 1 starts to separate from the battery holder 7 based on that the two electrodes are no longer in a state of being connected to each other.

The cover sensing module 1220 includes a pressure sensor detecting a force applied to the battery cover 1, and the pressure sensor may be provided to detect a value greater than or equal to the reference pressure value when the battery cover 1 is locked to the reference lock position of the battery holder 7. In this case, the at least one processor 118 may determine that the battery cover 1 starts to separate from the battery holder 7, based on the detecting that the pressure value of the pressure sensor falls below the reference pressure value.

The cover sensing module 1220 includes a switch, and the switch may be provided to be pushed when the battery cover 1 is locked to the reference lock position of the battery holder 7. In this case, the at least one processor 118 may determine that the battery cover 1 starts to separate from the battery holder 7, based on that the pushing of the switch is released.

The wireless device 20 may further include a voice output module (not shown) such as a speaker. The at least one processor 118 may output a notification notifying that the operation of the wireless device 20 is finished through the voice output module, based on the detecting that the battery cover 1 starts to separate from the battery holder 7.

The at least one processor 118 may detect whether the battery cover 1 is locked to the reference lock position of the battery holder 7 via the cover sensing module 1220, after the wireless device 20 is turned on.

Based on the determination that the battery cover 1 is not locked to the reference lock position of the battery holder 7, the at least one processor 118 may output a notification that guides that the locking degree of the battery cover 1 with respect to the battery holder 7 is to be improved.

Based on the determination that the battery cover 1 is locked to the reference lock position of the battery holder 7, the at least one processor 118 may output a notification sound notifying that the battery cover 1 is locked to the reference lock position of the battery holder 7.

The at least one processor 118 may output a notification notifying that the battery cover 1 starts to separate from the battery holder 7, based on the sensing that the battery cover 1 starts to primarily separate from the battery holder 7 via the cover sensing module 1220.

The at least one processor 118 may perform the processes for finishing the operation of the wireless device 20, based on the sensing that the battery cover 1 starts to secondarily separate from the battery holder 7, that is, separate more than the primary separation, via the cover sensing module 1220.

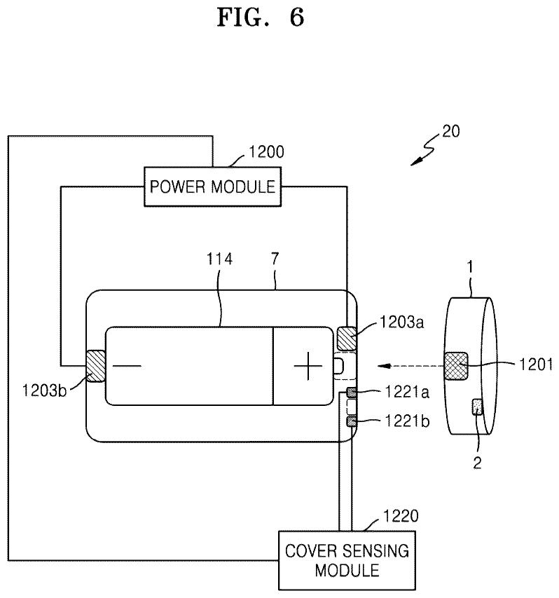

FIG. 6 is a diagram showing the cover sensing module of the wireless device 20 according to an embodiment.

Referring to FIG. 6, the battery holder 7 may include a cover sensing electrodes 1221a and 1221b separated from first and second power electrodes 1203a and 1203b of the power module 1200. The power electrodes 1203a and 1203b included in the battery holder 7 may be separated from each other. Also, the cover sensing electrodes 1221a and 1221b included in the battery holder 7 may be separated from each other.

As the battery cover 1 comes into contact with the battery holder 7, a main conductor 1201 provided inside the battery cover 1 is connected to one pole of the battery 114, and at the same time, the main conductor 1201 may be connected to the first power electrode 1203a of the battery holder 7. The second power electrode 1203b of the battery holder 7 may be connected to the other pole of the battery 114. As the first power electrode 1203a of the battery holder 7 is connected to one pole of the battery 114 and the second power electrode 1203b of the battery holder 7 is connected to the other pole of the battery 114, the power module 1200 acquires the power of the battery 114 and supplies the power to the modules in the wireless device 20.

After the battery 144 is connected the power electrodes 1203a and 1203b, when the battery cover 1 comes in closer contact with the battery holder 7, the conductor 2 of the battery cover 1 may be connected to the cover sensing electrodes 1221a and 1221b of the battery holder 7. As the conductor 2 in the battery cover 1 is connected to the cover sensing electrodes 1221a and 1221b of the battery holder 7, the electric current may flow in the cover sensing electrodes 1221a and 1221b. The cover sensing module 1220 may detect current values of the cover sensing electrodes 1221a and 1221b. The wireless device 20 may determine that the battery cover 1 is locked to the reference lock position of the battery holder 7, based on that the current value rises to the reference or greater.

Based on the determination that the battery cover 1 is locked to the reference lock position of the battery holder 7, the wireless device 20 may output a notification sound or notification message notifying that the battery cover 1 is normally locked to the battery holder 7.

According to an embodiment, after the battery 144 is connected to the power electrodes 1203a and 1203b, as the current values of the cover sensing electrodes 1221a and 1221b do not rise to the reference or greater for a preset time duration, the wireless device 20 may output a notification sound indicating that the battery cover 1 is not normally locked to the battery holder 7 or a notification sound requesting the battery cover 1 to be further coupled to the battery holder 7.

When the battery cover 1 is locked to the reference lock position of the battery holder 7, the battery cover 1 may be separated from the wireless device 20 for battery replacement.

As the battery cover 1 starts to separate from the battery holder 7, the conductor 2 in the battery cover 1 may be separated from the cover sensing electrodes 1221a and 1221b of the battery holder 7. While the power electrodes 1203a and 1203b are connected to the battery 144, the cover sensing electrodes 1221a and 1221b are disconnected, and accordingly, the current may not flow in the cover sensing electrodes 1221a and 1221b. The wireless device 20 may determine that the battery cover 1 starts to separate from the battery holder 7 based on that the current value of the cover sensing module 1220 descends to the reference or less.

Based on the determination that the battery cover 1 starts to be isolated from the battery holder 7, the wireless device 20 may perform the sequence for finishing the operation of the wireless device 20.

Based on the determination that the battery cover 1 starts to separate from the battery holder 7, the wireless device 20 may output a notification sound notifying that the battery cover 1 is separating from the battery holder 7.

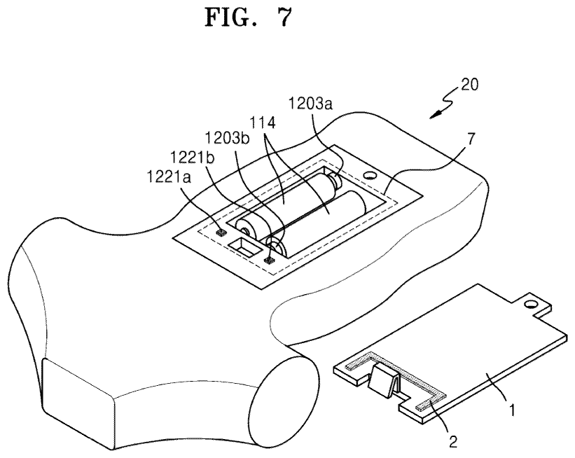

FIG. 7 is a diagram showing the cover sensing module of the wireless device 20 according to an embodiment.

Referring to FIG. 7, the wireless device 20 may include the battery cover 1 covering the battery holder 7.

The battery holder 7 may include the cover sensing electrodes 1221a and 1221b at portions coming into contact with the battery cover 1. Also, the battery cover 1 may include the conductors at the portions coming into contact with the cover sensing electrodes 1221a and 1221b of the battery holder 7. When the battery cover 1 is fixed to the battery holder 7, the conductors 2 of the battery cover 1 may connect the cover sensing electrodes 1221a and 1221b of the battery holder 7 to each other.

As the cover sensing electrodes 1221a and 1221b are connected to each other, the wireless device 20 may determine that the battery cover 1 is fixed to the battery holder 7.

As a user input for uncovering the battery cover 1 from the battery holder 7 is received, the conductors 2 of the battery cover 1 may be separated from the cover sensing electrodes 1221a and 1221b of the battery holder 7. As the conductors 2 are separated from the cover sensing electrodes 1221a and 1221b, the current does not flow in the cover sensing electrodes 1221a and 1221b any more, and thus, the wireless device 20 determines that the battery cover 1 is separated from the battery holder 7, and may perform the sequence for finishing the operation of the wireless device 20.

According to the embodiment, the wireless device 20 may perform the sequence for finishing the operation of the wireless device 20 after outputting a notification sound or notification message notifying that the sequence for finishing the operation of the wireless device 20 is to be performed.

According to an embodiment, based on the determination that the battery cover 1 is separated from the battery holder 7, the wireless device 20 may output a notification sound or notification message that guides the wireless device 20 has to be turned off before withdrawing the battery.

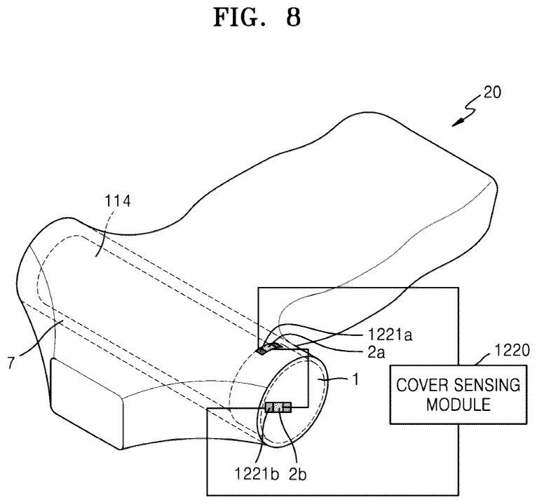

FIG. 8 is a diagram illustrating a method of providing a notification for securing a waterproof performance of the wireless device 20, according to an embodiment.

Referring to FIG. 8, the wireless device 20 may determine whether the battery cover 1 is locked to a position securing the waterproof of the wireless device 20 via the cover sensing module 1220.

According to an embodiment, at least one of the cover sensing electrodes 1221a and 1221b located in the battery holder 7 may be provided at the deepest location (location of 1221a in FIG. 8) where the battery cover 1 reaches when the battery cover 1 is locked to a preset position. For example, when the battery cover 1 is a rotation-locking type, one cover sensing electrode 1221a may be located at the end of a screw valley in the battery holder 7 and a conductor 2a may be provided at the end of a screw thread of the battery cover 1.

According to an embodiment, based on the determination that the locking is not made to the position securing the waterproof, the wireless device 20 may output a notification sound notifying that the battery cover 1 is to be locked to the position set in advance.

According to the embodiment, based on the determination that the locking is not made to the position securing the waterproof, the wireless device 20 may output a notification sound notifying that the battery cover 1 is not locked to the position set in advance.

According to the embodiment, based on the determination that the locking is made to the position securing the waterproof, the wireless device 20 may output a notification sound notifying that the battery cover 1 is locked to the position set in advance.

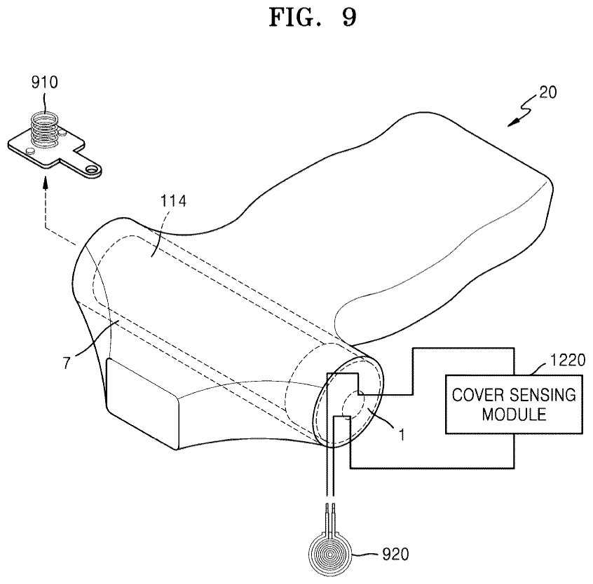

FIG. 9 is a diagram illustrating a method of sensing, by the wireless device 20, sensing opening of a battery cover by using a pressure sensor, according to an embodiment.

Referring to FIG. 9, the cover sensing module 1220 of the wireless device 20 may include a pressure sensor 920. The wireless device 20 may sense the opening of the battery cover 1 by using the pressure sensor 920. The wireless device 20 may determine whether the battery cover 1 is coupled to the predetermined position by using the pressure sensor 920.

The wireless device 20 may include a spring 910 inside the battery holder 7 (or inside the battery cover 1), and the spring 910 may be used as one power electrode (1203a or 1203b of FIG. 6). The spring 910 may apply the pressure to the battery 114 so as to increase a contact force between the battery 114 and the power electrodes 1203a and 1203b (see FIG. 6).

The pressure sensor 920 may be provided inside the battery holder 7 or inside the battery cover 1. For example, the pressure sensor 920 may be located inside the battery cover 1 as shown in FIG. 9. Also, for example, the pressure sensor 920 may be located between the inside of the battery holder 7 and the spring 910.

Accordingly, when the battery cover 1 is coupled to the battery holder 7, the pressure sensor 920 may detect the force applied by the spring 910 to the battery cover 1.

Also, the wireless device 20 may determine whether the battery cover 1 is coupled to a position determined in advance based on the force applied to the battery cover 1. For example, based on that the pressure value detected by the pressure sensor 920 is greater than or equal to a reference pressure value, the wireless device 20 may determine that the battery cover 1 is coupled to the position determined in advance.

Also, the wireless device 20 may sense whether the battery cover 1 starts to be opened based on the force applied to the battery cover 1. For example, based on that the pressure value detected by the pressure sensor 920 is lowered less than the reference pressure value, the wireless device 20 may determine that the battery cover 1 starts to open.

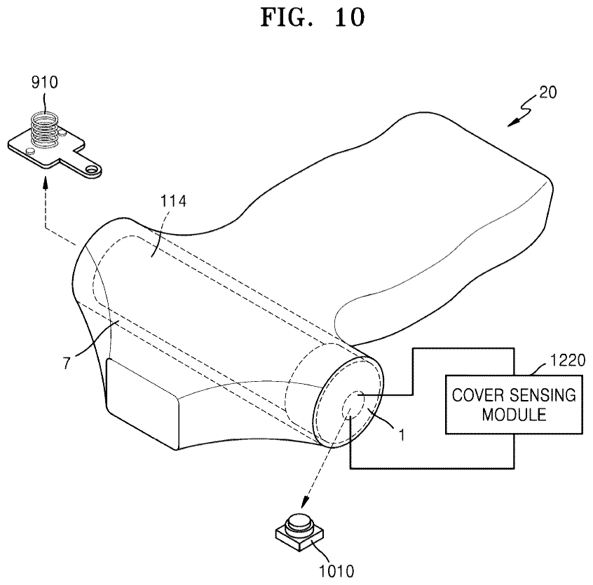

FIG. 10 is a diagram illustrating a method of sensing, by the wireless device 20, opening of a battery cover by using a switch, according to an embodiment.

Referring to FIG. 10, the cover sensing module 1220 of the wireless device 20 may include a switch 1010. The wireless device 20 may sense the opening of the battery cover 1 by using the switch 1010. The wireless device 20 may determine whether the battery cover 1 is coupled to the predetermined position by using the switch 1010.

The wireless device 20 may include the switch 1010 inside the battery cover 1 (or inside of the battery holder 7 contacting one electrode of the battery 114). When the battery cover 1 is coupled to the position determined in advance, the switch 1010 may be pushed due to the tension of the spring 910.

The wireless device 20 may determine whether the battery cover 1 is coupled to the predetermined position based on that the switch 1010 is pushed.

Also, the wireless device 20 may determine that the battery cover 1 starts to open based on that the pushing of the switch 1010 is released.

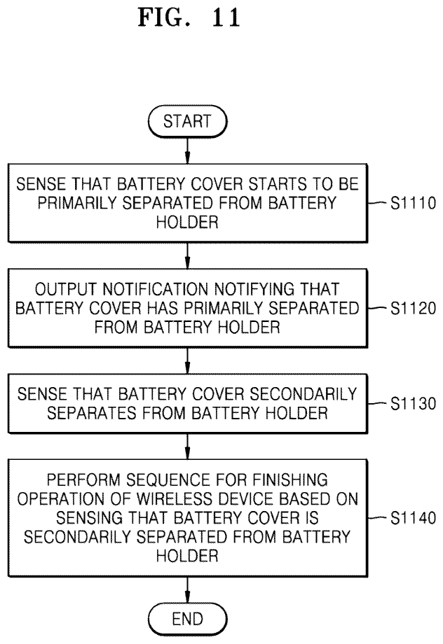

FIG. 11 is a flowchart illustrating a method of finishing the operation of the wireless device 20 when the wireless device 20 senses opening of a battery cover, according to an embodiment.

In operation S1110, the wireless device 20 may sense the battery cover is primarily separated from the battery holder.

The wireless device 20 may include sensing portions (e.g., electrode plates) for sensing a locking degree of the battery cover at a first position and a second position of the battery holder. The first position may be a position sensed by the cover sensing module when the battery cover is locked to a maximum locking position of the battery holder.

The second position may be a position sensed by the cover sensing module when the battery cover is locked less than the maximum locking position. For example, the second position may be an intermediate position between the maximum locking position and a minimum locking position of the battery holder. The first position and the second position both may be positions where the conductors of the battery cover are still in contact with the battery in the battery holder and the power is supplied to the wireless device 20.

When a battery cover is not sensed because a user input for separating the battery cover is received while the sensing portion located at the first position senses the battery cover, the wireless device 20 may sense that the battery cover is primarily separated from the battery holder.

In operation S1120, the wireless device 20 may output a notification notifying that the battery cover has primarily separated from the battery holder.

The notification notifying that the battery cover has primarily separated from the battery holder may include a notification buzzer sound corresponding to the primary separation, a voice notification sound notifying that the battery cover starts to separate, or a notification notifying that the sequence for finishing the operation of the wireless device 20 is to be performed, but is not limited thereto.

In operation S1130, the wireless device 20 may sense that the battery cover is secondarily separated from the battery holder.

As a user input for further separating the battery cover is received after the battery cover is primarily separated from the battery holder, the battery cover may be sensed by the sensing portion located at the second position.

Based on that the battery cover is not sensed after the battery cover is sensed by the sensing portion located at the second position, the wireless device 20 may sense that the battery cover is secondarily separated from the battery holder.

In operation S1140, the wireless device 20 may perform the sequence for finishing the operation of the wireless device 20 based on that the secondary separation of the battery cover from the battery holder is sensed.

Operation S1140 may be described with reference to operation S420 of FIG. 4.

Accordingly, when the battery cover is unlocked without the intention of the user, the wireless device 20 may notify the user to normally lock the batter cover again without finishing the operation of the wireless device 20.

What is claimed is:

1. A wireless device including a replaceable battery, the wireless device comprising:
a power supply module configured to supply power from the battery included in the wireless device;
a cover sensing module configured to sense a coupling degree of a battery cover with respect to a battery holder into which the battery is inserted;
a memory configured to store instructions; and
at least one processor including processing circuitry,
wherein the instructions, when executed individually or collectively by the at least one processor, cause the wireless device to:
sense, via the cover sensing module, that the battery cover starts to separate from the battery holder; and
perform a sequence for finishing operation of the wireless device based on the sensing that the battery cover starts to separate from the battery holder.

2. The wireless device of claim 1, wherein the cover sensing module includes two separate electrodes which are connected to each other when the battery cover is locked to a reference lock position of the battery holder, and
the instructions, when executed by the at least one processor, cause the at least one processor to determine that the battery cover starts to separate from the battery holder based on detecting that the two electrodes are no longer in a state of being connected to each other.

3. The wireless device of claim 1, wherein the cover sensing module includes a pressure sensor detecting a force applied to the battery cover, the pressure sensor is configured to detect a value greater than or equal to a reference pressure value when the battery cover is locked to a reference lock position of the battery holder, and
the instructions, when executed by the at least one processor, cause the at least one processor to determine the battery cover starts to separate from the battery holder based on sensing that a pressure value of the pressure sensor falls below the reference pressure value.

4. The wireless device of claim 1, wherein the cover sensing module includes a switch that is pushed when the battery cover is locked to a reference lock position of the battery holder, and
the instructions, when executed by the at least one processor, cause the at least one processor to determine that the battery cover starts to separate from the battery holder based on detecting that the pushing of the switch is released.

5. The wireless device of claim 1, wherein the wireless device comprises an ultrasound transmitter transmitting ultrasound waves and an ultrasound receiver receiving an ultrasound echo signal, and
the sequence for finishing the operation of the wireless device includes at least one of an operation of stopping transmitting ultrasound waves by controlling the ultrasound transmitter, an operation of stopping power supply to the ultrasound transmitter, an operation of stopping reception of the ultrasound wave by controlling the ultrasound receiver, or an operation of stopping power supply to the ultrasound receiver.

6. The wireless device of claim 1, wherein the instructions, when executed by the at least one processor, cause the at least one processor to output a notification notifying that the operation of the wireless device is finished based on the sensing that the battery cover starts to separate from the battery holder.

7. The wireless device of claim 1, wherein the instructions, when executed by the at least one processor, cause the at least one processor to:
after the wireless device is turned on, detect whether the battery cover is locked to a reference lock position of the battery holder via the cover sensing module; and
based on a determination that the battery cover is not locked to the reference lock position of the battery holder, output a notification for guiding that a locking degree of the battery cover with respect to the battery holder is to be improved.

8. The wireless device of claim 7, wherein the notification for guiding that the locking degree of the battery cover with respect to the battery holder is to be improved includes a notification for guiding that the locking degree of the battery cover is to be improved in order to secure waterproofing of the wireless device.

9. The wireless device of claim 7, wherein the instructions, when executed by the at least one processor, cause the at least one processor to output a notification sound notifying that the battery cover is locked to the reference lock position of the battery holder, based on a determination that the battery cover is locked to the reference lock position of the battery holder.

10. The wireless device of claim 1, wherein the instructions, when executed by the at least one processor, cause the at least one processor to:
output a notification notifying that the battery cover starts to separate from the battery holder based on sensing, via the cover sensing module, that the battery cover is primarily separated from the battery holder; and
perform a sequence for finishing operation of the wireless device based on sensing, via the cover sensing module, that the battery cover starts to secondarily separate from the battery holder, more than the primary separation.

11. A method of controlling a battery-replaceable wireless device, the method comprising:
sensing, via a cover sensing module, that a battery cover starts to separate from a battery holder; and
performing a sequence for finishing operation of the wireless device based on the sensing that the battery cover starts to separate from the battery holder.

12. The method of claim 11, wherein the cover sensing module includes two separate electrodes which are connected to each other when the battery cover is locked to a reference lock position of the battery holder, and
the sensing of the battery cover starting to separate from the battery holder comprises determining that the battery cover starts to separate from the battery holder based on detecting that the two electrodes are no longer in a state of being connected to each other.

13. The method of claim 11, wherein the cover sensing module includes a pressure sensor detecting a force applied to the battery cover, the pressure sensor is configured to detect a value greater than or equal to a reference pressure value when the battery cover is locked to a reference lock position of the battery holder, and
the sensing of the battery cover starting to separate from the battery holder comprises determining that the battery cover starts to separate from the battery holder based on sensing that a pressure value of the pressure sensor has fallen below a reference pressure value.

14. The method of claim 11, wherein the cover sensing module includes a switch that is pushed when the battery cover is locked to a reference lock position of the battery holder, and
the sensing of the battery cover starting to separate from the battery holder comprises determining that the battery cover starts to separate from the battery holder based on sensing that pushing of the switch is released.

15. The method of claim 11, wherein the wireless device comprises an ultrasound transmitter transmitting ultrasound waves and an ultrasound receiver receiving an ultrasound echo signal, and
the sequence for finishing the operation of the wireless device includes at least one of an operation of stopping transmission of the ultrasound waves by controlling the ultrasound transmitter, an operation of stopping power supply to the ultrasound transmitter, an operation of stopping reception of the ultrasound wave by controlling the ultrasound receiver, or an operation of stopping power supply to the ultrasound receiver.

16. The method of claim 11, further comprising outputting a notification notifying that operation of the wireless device is terminated based on the sensing that the battery cover starts to separate from the battery holder.

17. The method of claim 11, further comprising:
after the wireless device is turned on, detecting, via the cover sensing module, whether the battery cover is locked to a reference lock position of the battery holder; and
based on a determination that the battery cover is not locked to the reference lock position of the battery holder, outputting a notification for guiding that a locking degree of the battery cover with respect to the battery holder is to be improved.

18. The method of claim 17, wherein the notification for guiding that the locking degree of the battery cover with respect to the battery holder is to be improved includes a notification for guiding that the locking degree of the battery cover is to be improved in order to secure waterproofing of the wireless device.

19. The method of claim 17, further comprising outputting a notification sound notifying that the battery cover is locked to the reference lock position of the battery holder, based on a determination that the battery cover is locked to the reference lock position of the battery holder.

20. The method of claim 11, wherein the performing of the sequence for finishing operation of the wireless device based on the sensing that the battery cover starts to separate from the battery holder comprises:
outputting a notification notifying that the battery cover starts to separate from the battery holder based on sensing, via the cover sensing module, that the battery cover is primarily separated from the battery holder; and
performing the sequence for finishing the operation of the wireless device based on sensing, via the cover sensing module, that the battery cover starts to secondarily separate from the battery holder, more than the primary separation.
